(19) United States
(12) Patent Application Publication
(10) Pub. No.: US 2015/0095268 A1
(43) Pub. Date: Apr. 2, 2015

(54) INTELLIGENT MULTI-USER TASK PLANNING

(71) Applicant: Apple Inc., Cupertino, CA (US)

(72) Inventors: Michael Froimowitz Greenzeiger, Sunnyvale, CA (US); Mehul K. Sanghavi, Sunnyvale, CA (US); Ravindra Phulari, San Jose, CA (US)

(73) Assignee: Apple Inc., Cupertino, CA (US)

(21) Appl. No.: 14/044,124

(22) Filed: Oct. 2, 2013

(51) Int. Cl. G06N 5/02

(52) U.S. Cl. CPC G06N 5/02
USPC 706/11

(57) ABSTRACT

The disclosed technology can utilize a task manifest to record items on a user's to do list, along with other users also associated with the task. The technology can analyze the availability of the users associated with a task, reoccurring aspects of each user's daily routine, among other data items to determine which associated user is best suited to handle a given task. In some embodiments, the present technology can also rearrange an associated user's schedule to accommodate performance of a task, remind a user assigned to a task to perform the task, and notify all associated users of new or completed tasks.

### TECHNICAL FIELD

The present technology pertains to task management applications, and more specifically pertains to intelligent task management applications with the ability to optimize task performance in multi-person environments.

### BACKGROUND

Consumers are increasingly relying on their computing devices as personal assistants to keep track of their daily tasks. Current solutions are able to keep track of time and location based inputs and to manage tasks for a single user.

Smart phones and tablets are becoming integral into our everyday lives. The features on these devices coupled with the amount of data mining available to each unit device can enable intelligent task planning of a much higher level. These devices offer robust calendaring, task management and other productivity applications already, but there is a gap in integrating these diverse touch points into a single unified management console which further takes into account task planning from other individuals in the household.

As task management software becomes further integrated into daily lives, it is necessary to extend the functionality of this software to more fully meet the needs of multi-person households with complex task planning requirements through the addition of full task scheduling and ordering capabilities based on a variety of new dimensions.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, devices, and non-transitory computer-readable storage media for providing an intelligent task management application. The disclosed technology can utilize a task manifest to record items on a user's to do list, along with other users also associated with the task. An intelligent task planner can select the best-suited user to perform the task by analyzing user availability, reoccurring aspects of a user's daily routine, a user's prior task performance history, among other data items.

The intelligent task planner can optimize task performance in several ways. For example, the intelligent task planner can combine a task with a user's current task to optimize task performance. If the task cannot be combined because the cannot be performed at the same task location, the intelligent task planner can group the task with a user's current task if the tasks can be performed within close proximity to one another. The intelligent task planner can also optimize task performance by reorganizing a user's calendar to create availability for a user to complete a task.

In some embodiments, the intelligent task planner can optimize task performance by assigning a new task location to the selected user, if the user comes within close proximity to a closer more convenient task location. In the alternative, the intelligent task planner may reassign a task to a different user if that user comes within closer proximity to a potential task location than the originally assigned user.

To select a user for a task, the intelligent task planner can analyze a user's task manifest to identify a task and users linked to the task. Once the task and the users linked to the task are identified, the intelligent task planner can determine the task preference criteria and user attributes. The intelligent task planner can determine the best-suited user to perform the task by analyzing the task preference criteria and user attributes of users linked to the task. Once the best-suited user is selected, the intelligent task planner assigns the task to the selected user and sends a notification of the user selected for the task to the selected user and other linked users.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary system embodiment of a task management system;

FIG. 2 illustrates an exemplary task manifest;

FIG. 3 illustrates an exemplary user database;

FIG. 4 illustrates an exemplary method embodiment of assigning a task to a user;

FIG. 5 illustrates an exemplary method embodiment of selecting a user for a task;

FIG. 6 illustrates an exemplary task rules model;

FIGS. 7A, 7B, and 7C illustrate an exemplary embodiment of a method of selecting a user for a task;

FIGS. 8A, 8B, and 8C illustrate an exemplary embodiment of a method of selecting a user for a task;

FIGS. 9A, 9B, and 9C illustrate an exemplary embodiment of a method of selecting a user for a task;

FIGS. 10A, 10B, and 10C illustrate an exemplary embodiment of a method of selecting a user for a task;

FIGS. 11A and 11B illustrates an exemplary embodiment of a computer system.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for an advanced task management application for use in multi-person environments. The disclosed technology can utilize a task manifest to record and manage tasks shared with multiple people. The technology can analyze the availability of the users associated with a task, reoccurring aspects of each user's daily routine, among other data items to determine which associated user is best suited to handle a given task. In some embodiments, the present technology can also rearrange an associated user's schedule to accommodate performance of a task, remind a user assigned to a task to perform the task, and notify all associated users of new or completed tasks.

The basic location in which tasks are stored is the task manifest. It consists of a list of tasks with a set of attributes defined below. Each manifest is linked to one or more users who are the ones responsible for completing the tasks on the list, e.g. the members of a household or the members of a work team. Each task is owned by one or more user linked to the manifest. If more than one user owns the task, that means that the task could conceivably be done by any of those users. Some tasks may only be performed by a single user (e.g. getting a pedicure or a haircut) so that user is the sole owner. Tasks may be created by any user linked to the manifest who may assign any set of linked users as owners. The task manifest is a user console which takes into consideration all the pending tasks (manually or auto created), user work and home schedules (calendars), time and prioritization (certain tasks can be done later, some lower priority tasks may be bumped up due to the availability of the task owners) etc. The manifest can be cloud-controlled as the same manifest setup with the appropriate user context is pushed down to all the connected devices.

Every task submitted to the system has several other task preference criteria: location, time duration, deadline, priority, users assigned, and task manifests with this task. Task location is the location or list of possible locations in which the task can be completed. For example, in the case of getting an oil change for one's car, location would be a list of all the possible service stations in the area. Time is the exact time the task must be done, or the time range in which it may be done, e.g. the days and hours which the service station is open. Duration is the estimated time it will take to complete the task, which may be input by whomever entered the task or loaded from a standard list of durations for task types. Deadline refers to the date and time the task must be completed by. Priority is the priority level which the task creator has assigned the task which may be further modified up or down by any owner.

Additionally, some tasks may consist of more than one step, e.g. first, dropping off a car at the shop and second, picking up the car after the work has been completed. An interface will be provided to split tasks into more than one step or to group multiple tasks together in order to indicate task dependencies.

In addition to the tasks placed on user schedules by the task planner, user schedules additionally maintain preferences set by the user for when they are available for task assignment. The user may have standard work hours during which they are not available or may prefer not to be disturbed at certain times. Users may have some times during which they prefer to get tasks done and other times during which they don't normally accomplish tasks but may be willing to consider one if it is of sufficient priority.

A task owner who has been assigned a task to perform at a certain time is automatically given a lock on the task, ensuring that no other user will have it automatically placed into their schedule. Additionally, an owner who plans to do a task which has not been assigned to them or was assigned for a different day may assign the task to themselves resulting in a lock. If a user takes a task assigned to another user, that user is immediately notified to avoid duplication.

The intelligent task planner will run every time there is a change in status of one of the tasks assigned to it aside from a normal scheduled task completion. These planner triggering events include: a task being skipped, a task taking longer than expected, an owner doing a task early, an owner taking a task assigned to another user, a new task being created, or an external event (e.g. car not ready for pickup when expected).

Task optimization takes into account the inherent constraints of which user can do which task, what tasks can be done at what times, and the expected durations to generate a basic eligible task list for users within the manifest.

The individual eligible task lists are unified into a master eligible task list sorted by ascending deadline to ensure that tasks which need to be completed by a deadline are done first. In the case of ties, the tasks are further ordered by priority.

Tasks are selected from the master eligible task list in order. If there is sufficient time open for more than a single one of the tasks, the Planner will attempt to schedule multiple tasks, noting the locations of two subsequent tasks and using mapping software to find the expected travel time. As there may be multiple possible locations for a given task, the system will do an exhaustive search of all orderings of multiple tasks and alternative locations for each (bearing in mind the user's preferences, including a maximum distance from the user's home, e.g. 50 miles). When multiple owners are involved, they will be optimized simultaneously to ensure that the owners who will have the least travel time (in addition to the aforementioned constraints) will receive the task.

After the planner has selected the best task or set of tasks to occupy the currently available time slots for each user, if any changes have been made the users' calendars are automatically updated and they receive notifications indicating the new tasks they have been assigned.

Additionally, a user who unexpectedly has free time may immediately request a task. In this case, the planner will prompt the user for how much time they have available. The planner will then trigger a new optimization as described above, taking into account the new available time.

If there are tasks in the manifest which cannot be scheduled to be completed by their deadlines, an alert will be sent to all owners that the tasks will not be completed in time. The owners can respond by changing the deadline, canceling the task, adding additional owners, adding additional free time to their calendars or ignoring it. If a task is ignored by all owners up until the deadline expires, the task will automatically be removed.

Smart tasks are tasks that are automatically created which require no user intervention. Smart tasks can vary from the simple automated bill pay reminders to more complex ones such as ‘turn off the heater pilot light’ upon detection of a long upcoming vacation. Other examples of smart tasks can include things like—(1) order ink refills for printers when the toner is low, (2) activate home alarm system remotely if the user left the house without activation, (3) ordering supplies such as groceries or prescriptions, (4) home setup precautions due to updated weather alerts etc.

In some embodiments, a user may initiate a task wrench, which is a hypothetical event or non-occurrence of an event that can change the task manifest significantly. For example, a wrench could include ‘Babysitter absent’ or ‘School closed due to rain’ which will automatically require the task planning system to re-map the entire set of pending/upcoming tasks taking into consideration which user will now have limited time due to the major change in schedule. A task wrench is important to note as the task planner needs to understand better over time as to how to react for the best outcome. Task wrenches can also be used by the user to simulate how their manifest would look like assuming those scenarios were to come true. For example, ahead of a busy week, a user could simulate the impact to their manifest by introducing simulated task wrenches. The updated manifest would now reflect how far reaching the impact was and the user could take preventive steps to ensure those scenarios don't occur or are reduced in significance due to their preparedness. Some task wrenches can be selected from a collection of common task wrenches or they can be custom created by a user.

As used herein the term “configured” shall be considered to interchangeably be used to refer to configured and configurable, unless the term “configurable” is explicitly used to distinguish from “configured”. The proper understanding of the term will be apparent to persons of ordinary skill in the art in the context in which the term is used.

As used herein, the term “user” shall be considered to mean a user of an electronic device(s). Actions performed by a user in the context of computer software shall be considered to be actions taken by a user to provide an input to the electronic device(s) to cause the electronic device to perform the steps embodied in computer software. In some instances a user can refer to a user account associated with a particular electronic device.

As described above, one aspect of the present technology is the gathering and use of data available from various sources to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, or any other identifying information.

The present disclosure recognizes that the use of such personal information data, in the present technology, can be used to the benefit of users. For example, the personal information data can be used to deliver targeted content that is of greater interest to the user. Accordingly, use of such personal information data enables calculated control of the delivered content. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publically available information.

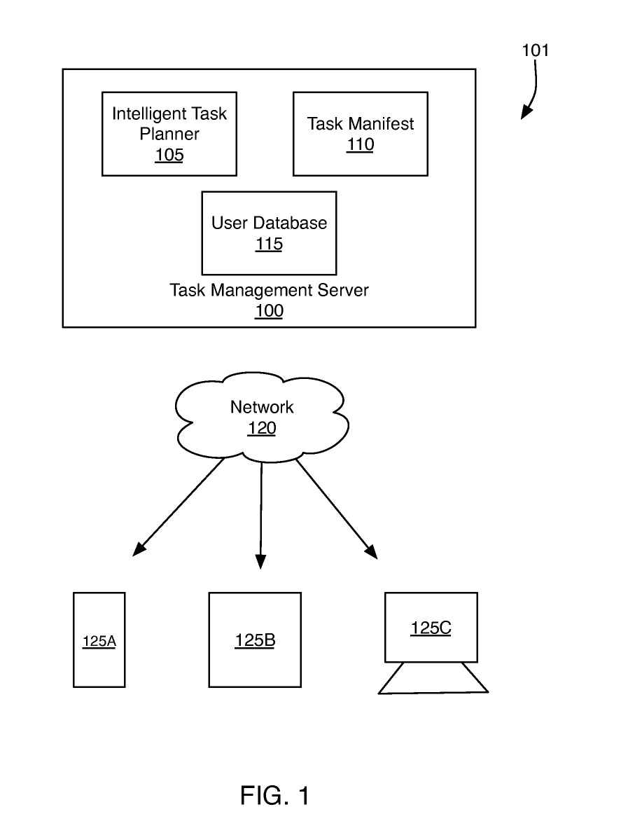

FIG. 1 illustrates a task management system 101. The cloud based task management system 101 includes a task management server 100, an intelligent task planner 105, a task manifest 110, a user database 115, a network 120, and client terminals 125.

The network 120 may be composed of multiple smaller networks and may be capable of using various communication standards, protocols and technologies. The communication standards, protocols and technologies, may include Global System for Portable Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (WiFi)(e.g. IEEE 802.11a, IEEE 802.11b, IEEE 802.11g and/or IEEE 802.11n), Wi-MAX, LTE Advanced, or any other similar communication protocol.

A client terminal 125 can be a desktop computer, a laptop computer, a netbook computer, a tablet computing device such as an IPAD, a personal digital assistant, a cellular telephone, a mobile smart phone such as an IPHONE, an entertainment system, a portable multimedia computing device such as an IPOD, or other similar computing platform (generically referred to herein as a “computer”). IPAD, IPHONE, and IPOD are computing devices distributed by Apple Inc. of Cupertino, Calif.

Each of the client terminals 125 can be associated with one or more respective users that operate the client terminals 125. The client terminals can communicate with the task management server 100, through the network 120 using either a dedicated application or a web browser running on each of the client terminals 125. The web browser can allow users to access a website associated with the task management server 100 over the network 120. Accordingly, a client terminal 125 can include a network interface capable of connection to the network 120 and an application program that communicates with the task management server 100.

In some embodiments, a client terminal 125 can include a system for determining location. For example, the client terminal 125 can include a Global Positioning System (GPS) device that utilizes one or more GPS satellites to determine the location of the client terminal 125. Alternatively or in addition to the GPS device, a client terminal 125 can include a cellular triangulation system that determines the location of the client terminal 125 based on its proximity to cellular towers. The location may be a street address, a set of longitude and latitude values, a distance from a landmark, or some other set of values to uniquely identify the location of the client terminal 125 on Earth. The system for determining location may be integrated into the client terminal 125 or it may be a peripheral device that is connected to the client terminal 125 through a wired or wireless peripheral bus (e.g. Universal Serial Bus (USB), IEEE 1394 (Firewire), Bluetooth, etc.).

The task management server 100 can be a single computer, a set of one or more computers working in parallel, or any other suitable computing platform. In some embodiments, task management server 100 can be a software module. The task management server 100 can be a networked device separate from a client as shown in FIG. 1, or it can be a module on a client device. In some embodiments, some functionality identified as being performed by task management server 100 can be spilt across one or more devices, including, but not limited to some functionality being performed on a client terminal 125 and some functionality being performed by a separate server device. For example, in some embodiments the present technology can be a cloud hosted service wherein client devices communicate with and through the cloud, while in some embodiments, the present technology can be implemented as a peer to peer service wherein the client devices communicate directly with each other through a network.

In conjunction with the client terminals 125, the task management server 100 manages the assignment of tasks between users linked to the task manifest. The task management server 100 includes a task manifest 110 which stores information about the tasks, a user database 115 that can store information regarding users of the system that are associated to one or more tasks, and an intelligent task planner 105 that can analyze data in the task manifest 110, and user database 115 to manage the tasks. The task management server can also communicate with client terminals 125 to receive information about tasks and user's calendars, and to alert users regarding the status of tasks. Other inputs into the task management server 100 include, but are not limited to, weather feeds, maps, etc. Such inputs can be accessed directly by the task management server or indirectly through client terminals 125.

Tasks are either auto created or manually introduced to the system by users. The tasks are stored in task manifest 110. A task manifest consists of a list of tasks with a set of task preference criteria. Task preference criteria include, but are not limited to, task location 210, the time 205 or time range in which the task must be done, the duration 225 or estimated time it will take to complete a task, task deadlines 220 or the date the task must be completed by, task priority 215, users assigned 230 to a task, and other task manifests with this task 235. Tasks can be created by any user and users can assign any set of linked users as owners.

An intelligent task planner module 105 of the task management server 100 can optimize task performance when a new task is added or a change in the status of the task or another task associated with one of the users occurs. In some embodiments the present technology involves looking at a user's, or a group of users′, attributes and availabilities and using a cloud based network and an intelligent task planner to optimize task performance. The intelligent task planner uses task preference criteria stored in the task manifest and user attributes stored in a user database to assign tasks to the group.

In some embodiments the intelligent task planner can combine a task with a linked user's existing task if both tasks share the same task location. For example, if a linked user is assigned the task of picking up milk from the grocery store and a new task is created to pick up eggs from the grocery store, the task of picking up milk can be combined with the task of picking up eggs. In this example, when the new task of picking up eggs is created, the intelligent task planner accesses the linked user's task manifests to determine if a task currently exists with the grocery store as the task location. Once the task of picking up milk is identified in a linked user's task manifest, the task of picking up the eggs is combined with the task of picking up milk. The two individual tasks are now performed at one time at the same task location.

In the alternative, the intelligent task planner may also determine that tasks may not be completed at the same task location, but may be completed at two different task locations in close proximity to one another. For example, if a linked user is assigned the task of picking up money from an ATM and a new task is created to pick up dry cleaning, the two tasks can be grouped if task locations for each task exist in close proximity to one another. In this example, when the new task of picking up dry cleaning is created, the intelligent task planner accesses the linked user's task manifest to determine if a task currently exists with a task location in close proximity to the new task. Once the intelligent task planner determines that the task of picking up money from an ATM has an ATM task location in close proximity to the dry cleaning task location, the two individual tasks can be grouped and assigned to one user to be performed in the same time setting at two different task locations in close proximity to one another.

In some embodiments, the intelligent task planner can assign tasks to a linked user based on a linked user's availability. For example, when a new task is created, the intelligent task planner can determine users linked to the task and then access the user's database to determine if any linked users have availability to complete the task at the task time. In the event two or more users linked to the task have availability at the task time, the intelligent task planner can determine which user has the most available time, or can complete the task in the shortest amount of time.

In the alternative, the intelligent task planner can reorganize a user's calendar when no users linked to a task have availability to complete the task at the task time. For example, if a task is created and two users are linked to the task, the intelligent task planner can determine if either of the two users have availability to complete the task by accessing the linked users' databases. In the event no linked users have availability to complete the task, the task can either be rescheduled or a user's calendar may be reorganized to provide availability to complete the task.

In some embodiments, the intelligent task planner can assign tasks to users whose predicted daily travels includes the task location. For example, a user's cell phone or server can learn a lot about the user over time including learning a user's daily or weekly routine. When a new task is created, the intelligent task planner can assign the task to a user whose daily travels includes coming within close proximity to the task location.

In addition to learning a user's daily or weekly routine, the intelligent task planner can also learn the types of tasks users historically perform. Historical task performance data can be gathered from several places including other task manifests and user's task lists, user's calendars, other task management applications users subscribe to, etc. For example, if two linked users are available to complete a task, the intelligent task planner may assign the task to the user who historically completes this type of task.

In some embodiments, a user can schedule an event which consists of a list of tasks which have dependency on one another. If the user cancels the event, the intelligent task planner can provide a user with suggestions of other things the user should do. For example, if a user is hosting an outdoor party, there are a lot of tasks the user needs to complete in preparation for the party which can include reserving an outdoor space to have the party, hiring a food caterer, reserving a DJ to play music, etc. In this example, the task management server receives an input regarding rainy weather on the day of the party through weather feeds. The intelligent task planner can cancel the outdoor party due to the weather conditions and then provides the user with suggestions of other things the user should do such as canceling the caterer and DJ and canceling the reservations for the outdoor space.

In some embodiments, a user can schedule a meeting with multiple attendees. If the user cancels the meeting, the intelligent task planner can notify all corresponding users and suggest a new time for the meeting.

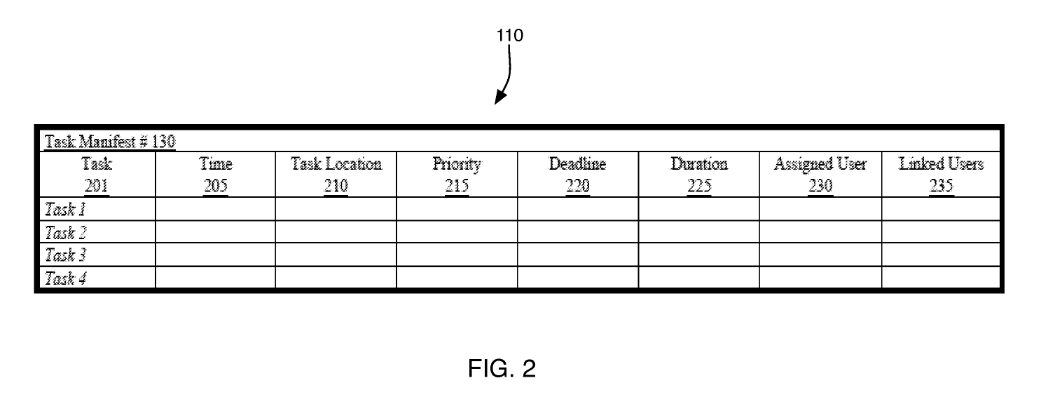

FIG. 2 shows a task manifest 110. In some embodiments, a task manifest 110 may include task preference criteria as depicted in FIG. 2. Task preference criteria may include, but are not limited to, time 205, task location 210, priority 215, deadline 220, duration 225, users assigned to the task 230 and users linked to this task 235. Each task manifest will contain a unique task manifest identification number. In FIG. 2., the unique task manifest identification number is task manifest #0130. Each task list is unique to a user, and is linked to a shared task manifest. Similarly, other user's task lists can link to the same shared manifest for shared tasks using the task manifest identification number. Once users are linked to a manifest, tasks may be modified by any user linked to the task through the manifest using a portable electronic device or computer and entered into the task manifest including task preference criteria.

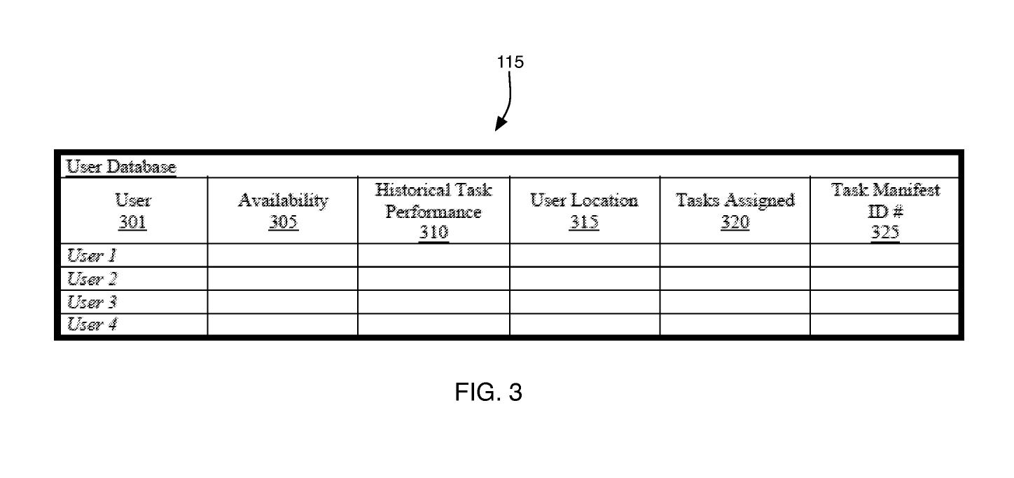

FIG. 3 illustrates a user database 300. In some embodiments, a user database 300 may include user attributes as depicted in FIG. 3. User attributes may include, but are not limited to, availability 305, historical task performance 310, user location 315, tasks assigned 320, and user task manifest identification number 325.

User availability 305 can be obtained by the task management server 100 from a user's calendar, other task management applications, social media accounts, email accounts, etc. or directly input to the task management server 100 through client terminals 125. In some embodiments, user availability 305 can be intelligently learned over time based on of a user's daily or weekly routine.

Historical task performance 310 is determined based on a users previous completion of a task identical to, similar or related to the present task. In some embodiments, historical task performance 310 is determined by the task management server 100 accessing user's calendars, other task management applications, social media accounts, email, etc. or analyzing previous tasks completed in the users associated task manifest 110.

User location 315 specifies a client terminals current location. In some embodiments, a client terminal 125 can include a system for determining location. For example, the client terminal 125 can include a Global Positioning System (GPS) device that utilizes one or more GPS satellites to determine the location of the client terminal 125. Alternatively or in addition to the GPS device, a client terminal 125 can include a cellular triangulation system that determines the location of the client terminal 125 based on its proximity to cellular towers. The location may be a street address, a set of longitude and latitude values, a distance from a landmark, or some other set of values to uniquely identify the location of the client terminal 125 on Earth. The system for determining location may be integrated into the client terminal 125 or it may be a peripheral device that is connected to the client terminal 125 through a wired or wireless peripheral bus (e.g. Universal Serial Bus (USB), IEEE 1394 (Firewire), Bluetooth, etc.).

Tasks assigned 320 to a respective user indicates all tasks currently assigned to a user at any given point in time. These tasks include tasks assigned 320 to a user from user's individual task manifest and tasks assigned 320 to a user from other user's task manifests. Tasks get removed upon completion of a task or when a task assigned to a user is assigned to another user by the intelligent task planner 105.

A task manifest identification number 325 is assigned to each task manifest. Each task manifest 110 will contain a unique task manifest identification number 325. In FIG. 2., the unique task manifest identification number is task manifest #0130. Each task list is unique to a user. However, since other users are associated to tasks in another user's task list, other user's task lists can be linked to a task manifest using the task manifest containing shared tasks through a task manifest identification number. Once users task lists are linked to a manifest, tasks may be modified by any user linked to the task through the manifest using a portable electronic device or computer and entered into the task manifest including task preference criteria.

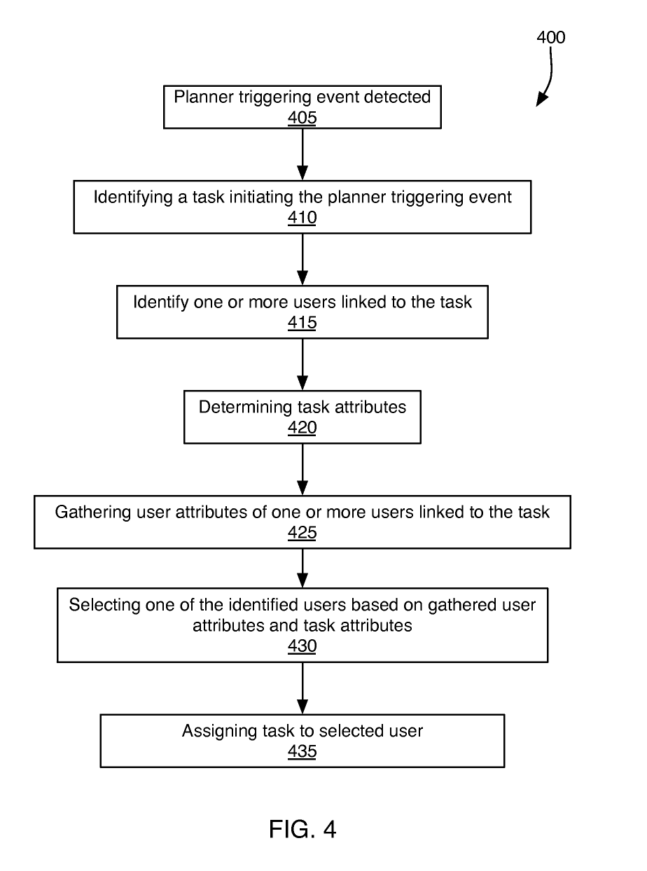

FIG. 4 illustrates an exemplary method embodiment for assigning a task to a user. As shown, the method begins at block 405 when a planner triggering event is detected. Planner triggering events include a task being skipped, a task taking longer than expected, an owner completing a task early, an owner taking or completing a task assigned to another user, a new task being created, or an external event occurring which affects performance of a task.

The method continues to block 410 where the task associated with the planner triggering event is identified. Existing tasks or new tasks that trigger the intelligent task planner can previously be entered into a task manifest. Identification of the task triggering the intelligent task planner includes identifying task manifests that include the task in their task list. The method then continues to block 415 where users linked to the task are identified by determining which user's task lists are linked to the task manifests that include the task. Next, task preference criteria of the identified task are determined in block 420. Task preference criteria may include, but are not limited to, time 205, task location 210, priority 215, deadline 220, duration 225, users assigned to the task 230 and all users linked to this task 235.

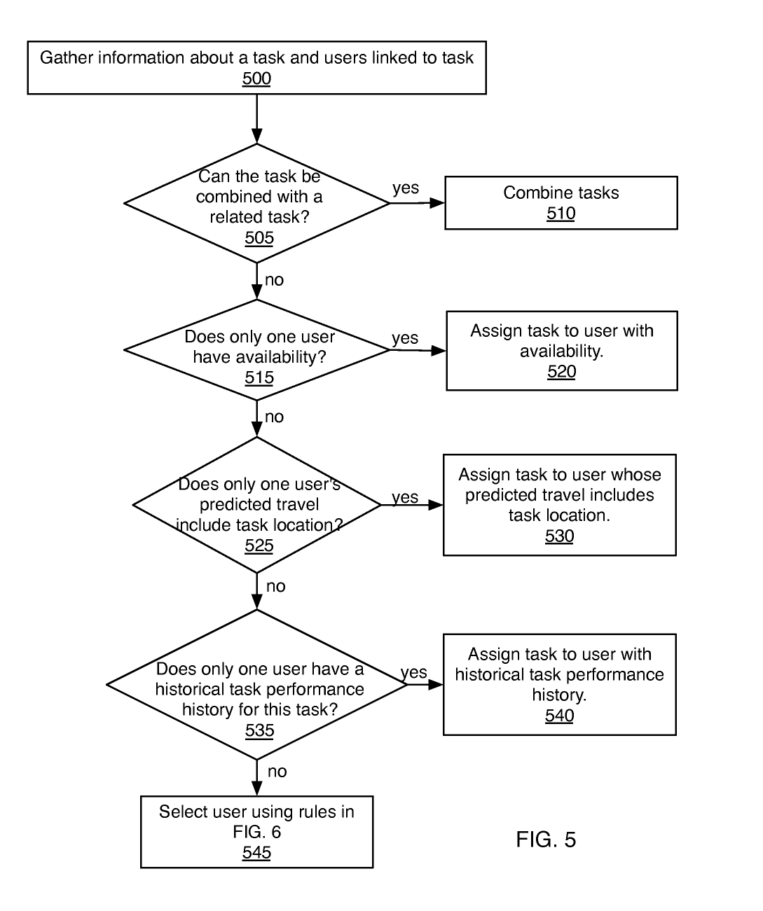

The method then continues to block 425 where user attributes are gathered for user's whose tasks lists are linked to the task manifests which include the task. User attributes may include, but are not limited to, availability 305, historical task performance 310, user location 315, tasks assigned 320, and task manifest identification number 325. Next, a user is selected to complete the identified task in block 430 from the pool of users identified in block 415. The user is selected in block 430 by analyzing the task preference criteria determined in block 420 and user attributes gathered in block 425 and selecting the user who is best suited to complete the task according to task assignment rules. The process by which the user is selected in block 425 is explained in greater detail in FIG. 5. Finally, the task is assigned to the selected user in block 435 and a notification is sent to all users linked to the task informing them of the user selected and assigned the task.

FIG. 5 illustrates an exemplary method embodiment for selecting a user for a task. As shown, the method begins at block 500 where information is gathered about a task and users linked to the task. When the intelligent task planner is triggered by a planner triggering event, the intelligent task planner can identify the task associated with the planner triggering event. The intelligent task planner can then access task manifests that include the task to determine task preference criteria for the task. The intelligent task planner can gather users' attributes by determining users linked to the task from the task preference criteria and then accessing the linked users databases.

The method continues to block 505 where the task can be analyzed to determine whether or not the task can be combined or grouped with a related task. In this step, the intelligent task planner can analyze the task preference criteria and determine if any users linked to the task have current tasks assigned that can be performed at either the same task location or within close proximity to the task location. If the tasks can be performed at the same task location the tasks are combined and if the tasks can be performed at two individual task locations within close proximity to each other the tasks can be grouped together as shown in 510.

If the tasks cannot be combined or grouped, the method continues to block 515 where user availability for users linked to the task is analyzed. In this step, the intelligent task planner accesses the user database(s) for a user(s) linked to the task to determine user availability. If only one user linked to the task has availability in his calendar to complete the task that user can be selected to complete the task as shown in 520. If more than one user has availability to complete the task, the intelligent task planner can select the user with the most availability or the user that can complete the task in the shortest amount of time. In the alternative, if no user(s) linked to the task has availability to complete the task, a user's calendar may be reorganized to provide availability for the user to complete the task.

If a user cannot be selected based off user availability data, the method continues to block 525 where a user(s) predicted travel is analyzed. The intelligent task planner, through cell phone use and servers, has the ability to learn a user's daily or weekly routine overtime. The intelligent task planner can use learned daily or weekly routines to predict where a user may be at any given time during the course of a day. If a user's predicted daily travel includes coming within close proximity to the task location at or near the task time, that user can be selected to complete the task as shown in 530.

If a user cannot be selected based off of users predicted travel, the method continues to block 535 where a user(s) task performance history is analyzed. The intelligent task planner can analyze linked users historical task performance history by accessing linked users preference criteria from their task manifests. If a user has historical task performance history for completing the task, that user can be assigned the task as shown in 540.

If no user can be selected based off of historical task performance history, the method continues to block 545 where additional rules are taken into consideration to determine which linked user is selected to complete the task.

These are just a few examples of how a user can be selected for a task and are not meant to be limiting. One skilled in the art would recognize that a user can be selected in any number of ways known in the art.

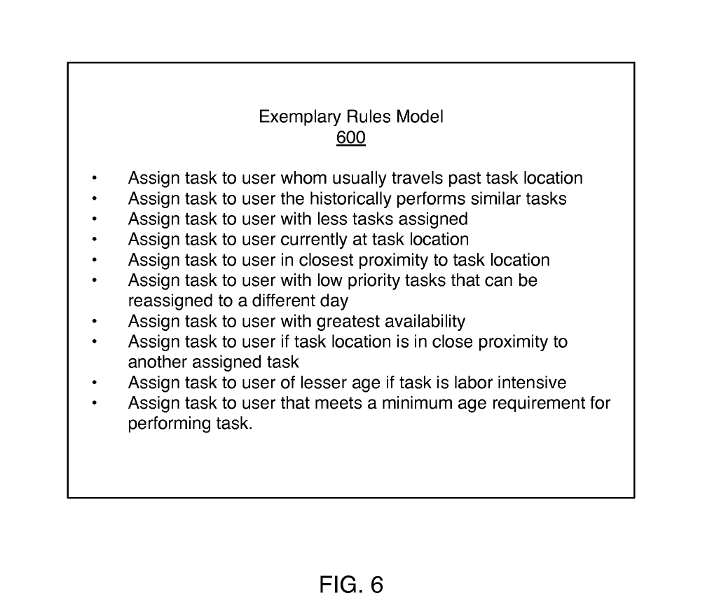

FIG. 6 illustrates an exemplary task rules model which lists different rules which may be utilized to select a user for a task.

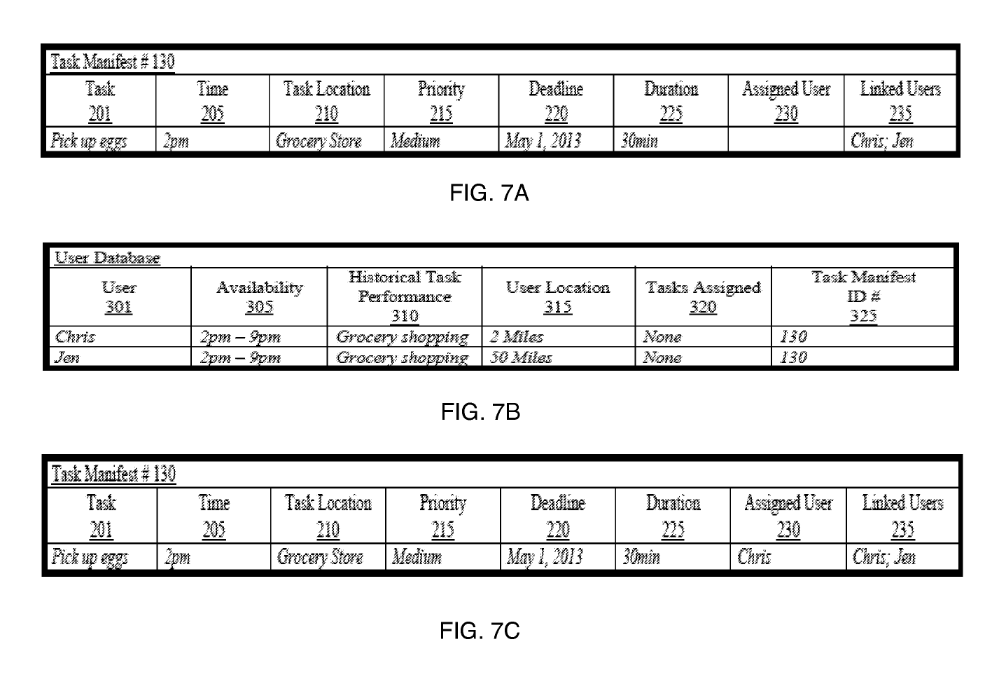

In FIGS. 7-10 a series of examples are provided to illustrate how a user is selected for a task, how tasks are combined for optimization, and how the technology reorganizes a user's calendar when necessary to complete tasks.

In FIG. 7A, Chris enters a task #1—pick up eggs—into task manifest #0130. In addition to linking himself to the task Chris also links his wife Jen to the task. Chris' and Jen's task lists are updated to include task #1. The task preference criteria for task #1 include time 205, task location 210, priority 215, deadline 220, duration 225, users assigned 230, and users linked to this task 235. Time 205 for task #1 was set for 2:00 pm. Priority for task #1 is set as medium. The task deadline for task #1 is set as May 1, 2013. Duration for task #1 is set as 30 minutes. Task location for task #1 is a general location and not a specific location. This is made evident by the task location for task #1 being listed as any grocery store as opposed to a specific grocery store. In a circumstance such as this where the task location is general, a task location will be specified for the user based on user location and may change or vary as the user GPS location changes. While a user such as Chris might get assigned the task (as discussed with respect to FIG. 7B), a different user linked to the task, such as Jen might receive a notification to accept the task (which removes Chris from being assigned the task) if that user comes in closer proximity to a potential task location. Finally, the users assigned for task #1 has yet to be determined because task preference criteria and user attributes have not been analyzed for task #1.

Moving forward to FIG. 7B user attributes for users linked to task #1 are provided in the user database 300. User attributes include availability 305, historical task performance 310, user location 315, tasks assigned 320, and task manifest identification number 325. As provided in FIG. 7B, Chris and Jen both have availability from 2:00 pm-9:00 pm, a historical task performance of grocery shopping, have no tasks currently assigned. However, Chris and Jen's user location vary significantly as Chris is currently 2 miles away from the nearest grocery store and Jen is 50 miles away from the nearest grocery store.

FIG. 7C illustrates task #1 being assigned to Chris's task manifest #0130 after all user attributes and task #1 preference criteria are analyzed. Here, the determining factor in assigning task #1 to Chris was Chris's proximity to a grocery store. However, because a user's location may change, the task may ultimately be assigned to another user linked to task #1 if that user comes within closer proximity to a grocery store before task #1 is completed provided that the user has availability in their schedule to complete the task. Additionally, FIG. 7C illustrates an updated task manifest. In some embodiments a notification can be pushed to all users linked to task #1, alerting them that a new task has been uploaded and assigned to a user.

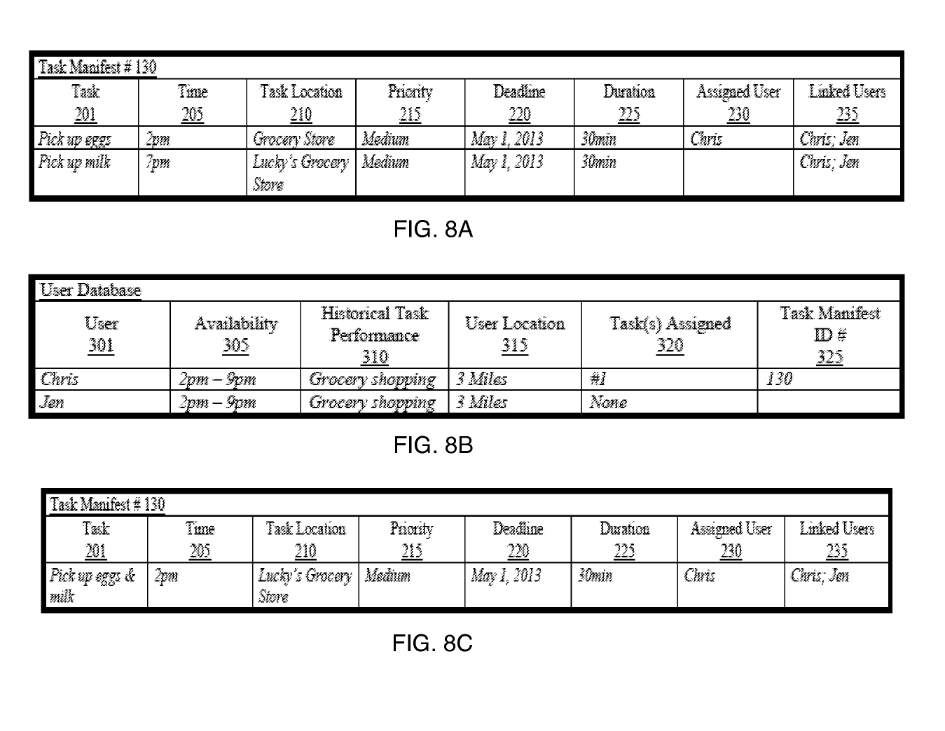

In FIG. 8A, Jen enters task #2—pick up milk—into task manifest #0130. In addition to linking hereself to the task, Jen also links her husband Chris to the task 235, and Chris' and Jen's task lists are updated to include task #2. The task preference criteria for task #1 include time 205, task location 210, priority 215, deadline 220, duration 225, users assigned 230, and users linked to this task 235. Time 205 for task #2 is set for 7:00 pm. Task location 210 for task #2 is a specific location as opposed to a general location in task #1. This is made evident by the task location for task #2 being specifically set as Lucky's grocery store as opposed to any grocery store. When a specific task location has been set by the user the task must be completed at this specific location. If multiple locations are available, the user will be directed to the closest location, and this location will not change or vary unless the user comes within closer proximity to another specific task location. Priority for task #1 was set as medium. The task deadline for task #2 was set for May 1, 2013. Duration for task #1 was set for 30 minutes. The users assigned for task #2 has yet to be determined because task preference criteria and user attributes have not been analyzed for task #2.

As illustrated in FIG. 8B, user attributes for users linked to task #1 are provided in the user database 300 and task preference criteria for tasks already assigned to users linked to task #1 are provided in the task manifest 110. User attributes include availability 305, historical task performance 310, user location 315, tasks assigned 320, and task manifest identification number 325. As provided in FIG. 8B, Chris has availability from 2:30 pm-9 pm and Jen has availability from 2:00 pm-9:00 pm, Chris and Jen both have a historical task performance of grocery shopping. In this example, Chris and Jen's user locations are exactly the same as Chris and Jen are both currently 3 miles away from the nearest Lucky's grocery store. In this example, only Chris has a preexisting task assigned to him, to pick up eggs from a grocery store, which is defined in task manifest #0130 (FIG. 7A).

FIG. 8C illustrates task #2 being assigned to Chris and the task being merged into one task in manifest #0130 based on an analysis of all user attributes, task #2 preference criteria, and Chris's task manifest. Here, the determining factor in assigning task #2 to Chris was Chris previously being assigned task #1. To optimize task performance, task #1 and task #2 are combined into one task, merged into a common task and assigned to Chris because of the similarity between the two tasks and the ability to complete both tasks at one location. The time for task #2 was originally set for 7:00 pm. After combining the tasks, the time for task #1 and task #2 is now 2:00 pm. Additionally, task #2, required the specific location of Lucky's grocery store. Since task #1 did not require a specific task location, the task location for the combined tasks will change from any grocery store, the previous task location for task #1, to Lucky's grocery store. However, the task location may vary or change if the user selected for task #2 comes within closer proximity to another Lucky's location. Finally, a different user linked to the task may receive a notification to accept the task if that user comes in closer proximity to a Lucky's grocery store and that user has availability to complete the task.

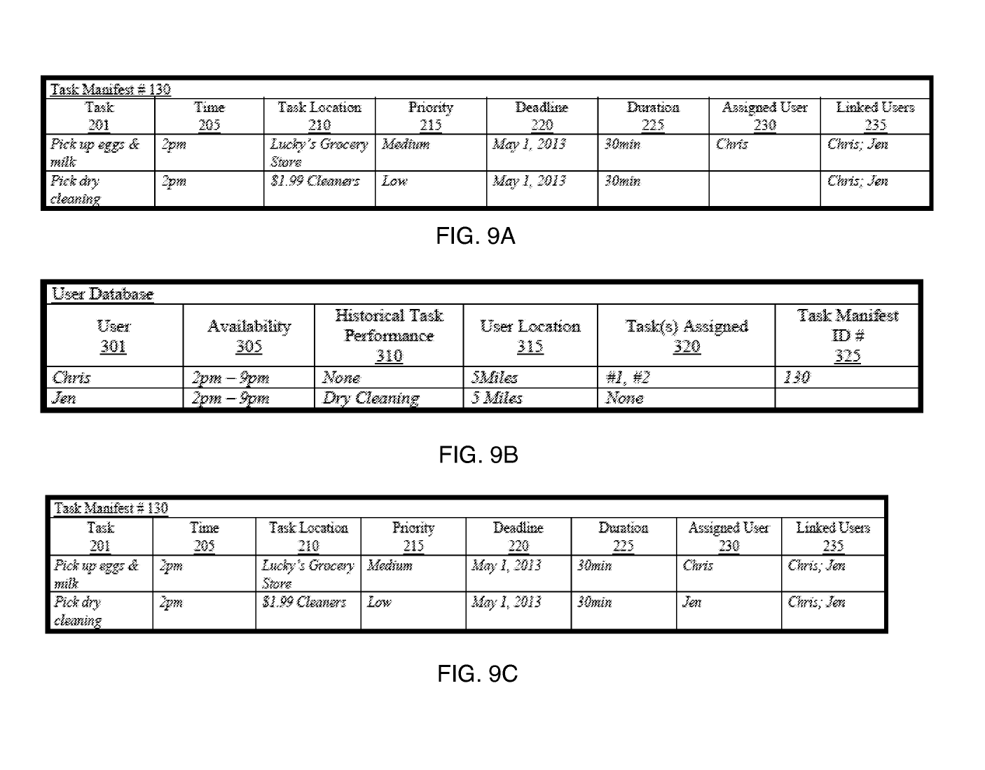

In FIG. 9A, Chris has entered task #3—pick up dry cleaning—into task manifest #0130. Chris also associates his wife Jen with the task 235. The task preference criteria for task #3 include time 205, task location 210, priority 215, deadline 220, duration 225, users assigned 230, and users associated with this task 235. Time 205 for task #3 is set for 7:00 pm. Task location 210 for task #3 is a specific location as opposed to a general location in task #1. This is made evident by the task location for task #3 being specifically set as $1.99 cleaners. When a specific task location has been set by the user, the task must be completed at this specific location. If multiple locations are available, the user will be directed to the closest location, and this location will not change or vary unless the user comes within closer proximity to another specific task location. Unlike task #2, task #3 must be completed at the $1.99 cleaners because multiple locations are not available. Priority for task #3 was set as low. The task deadline for task #3 was set for May 1, 2013. Duration for task #1 was set for 30 minutes.

As illustrated in FIG. 9B, user attributes for users linked to task #3 are provided in the user database 300 and task preference criteria for task already assigned to users linked to task #3 are provided in the task manifest 100. User attributes include availability 305, historical task performance 310, user location 315, tasks assigned 320, and task manifest identification number 325. As provided in FIG. 9B, Chris has availability from 2:30 pm-9 pm and Jen has availability from 2:00 pm-9:00 pm, Chris and Jen's user locations are exactly the same as Chris and Jen are both currently 5 miles away from the $1.99 cleaners, and their task manifest identification numbers are both provided and linked to task #3. However, only Jen has a historical task performance for dry cleaning. In this example, only Chris has a preexisting task assigned to him, task #1 and task #2 to pick up eggs and milk, which is provided in task manifest #0130.

FIG. 9C illustrates task #3 being assigned to Jen's after all user attributes, task #3 preference criteria, and Chris's tasks are analyzed. Here, the determining factors in assigning task #3 to Jen is Jen having availability at 2:00 pm, Chris not having availability at 2:00 pm because he is already assigned task #1 and task #2 at that time, and Jen's historical task performance for picking up dry cleaning.

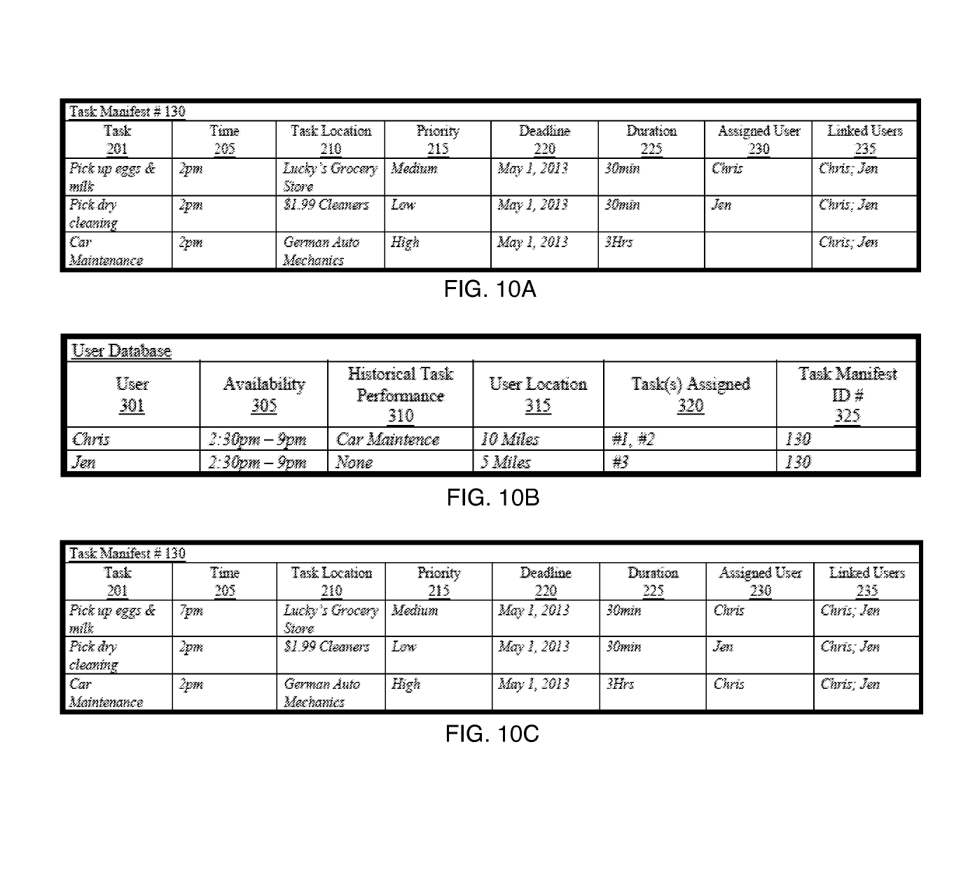

In FIG. 10A, Jen enters task #4—car maintenance—into task manifest #0130. Jen also links her husband Chris. The task preference criteria for task #4 include time 205, task location 210, priority 215, deadline 220, duration 225, users assigned 230, and task manifests with this task 235. Time 205 for task #3 is set for 2:00 pm. Task location 210 for task #4 is a specific location as opposed to a general location in task #1. This is made evident by the task location for task #4 being specifically set as German Auto Mechanics. When a specific task location has been set by the user the task must be completed at this specific location. If multiple locations are available, the user will be directed to the closest location, and this location will not change or vary unless the user comes within closer proximity to another specific task location. Unlike task #2, task #4 must be completed at the German Auto Mechanics because multiple locations are not available. Priority for task #4 is set as high. The task deadline for task #4 is set for May 1, 2013. Duration for task #1 is set for 3 hours.

As illustrated in FIG. 10B, user attributes for users linked to task #4 are provided in the user database 300 and task preference criteria for tasks already assigned to users linked to task #4 are provided in the task manifest 100. User attributes include availability 305, historical task performance 310, user location 315, tasks assigned 320, and task manifest identification number 325. As provided in FIG. 10B, Chris and Jen both have availability from 2:30 pm-9:00 pm, tasks currently assigned to them, and their task manifest identification numbers are both provided and linked to task #3. However, only Chris has a historical task performance for car maintenance, Chris's user location is currently 10 miles from the task location and Jen's user location is currently 5 miles from the task location.

FIG. 10C illustrates task #4 being assigned to Chris after all user attributes, task #4 preference criteria, Chris's task manifest, and Jen's task manifest are analyzed. Here, the determining factors in assigning task #4 to Chris is Chris having historical task performance of car maintenance and the task having a high priority. In this example, Chris and Jen both have time conflicts as they both have tasks currently assigned at 2:00 pm. Although Jen's user location is closer to the task location, Chris's historical task performance and the task priority make Chris the best-suited user to complete the task. Chris's scheduled is reorganized to allow performance of tasks #1, task #2 and task #4. Task #4 is set for 2:00 pm and task #1 and task #2 are reorganized for 7:00 pm which provides Chris with enough time to complete task #4 and travel to the task location of task #1 and task #2.

These are just a few examples of how a user can be selected for a task and are not meant to be limiting. One skilled in the art would recognize that a user can be selected in any number of ways known in the art.

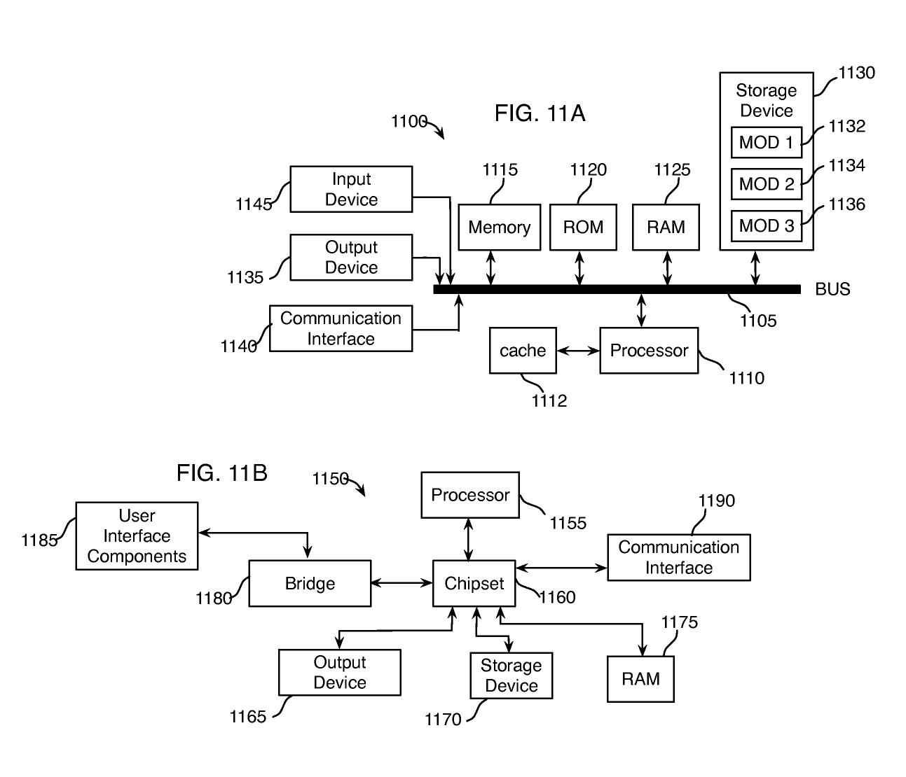

FIG. 11A, and FIG. 11B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 11A illustrates a conventional system bus computing system architecture 1100 wherein the components of the system are in electrical communication with each other using a bus 1105. Exemplary system 1100 includes a processing unit (CPU or processor) 1110 and a system bus 1105 that couples various system components including the system memory 1115, such as read only memory (ROM) 1120 and random access memory (RAM) 1125, to the processor 1110. The system 1100 can include a cache of high-speed memory connected directly with, in close proximity to, or integrated as part of the processor 1110. The system 1100 can copy data from the memory 1115 and/or the storage device 1130 to the cache 1112 for quick access by the processor 1110. In this way, the cache can provide a performance boost that avoids processor 1110 delays while waiting for data. These and other modules can control or be configured to control the processor 1110 to perform various actions. Other system memory 1115 may be available for use as well. The memory 1115 can include multiple different types of memory with different performance characteristics. The processor 1110 can include any general purpose processor and a hardware module or software module, such as module 1 1132, module 2 1134, and module 3 1136 stored in storage device 1130, configured to control the processor 1110 as well as a special-purpose processor where software instructions are incorporated into the actual processor design. The processor 1110 may essentially be a completely self-contained computing system, containing multiple cores or processors, a bus, memory controller, cache, etc. A multi-core processor may be symmetric or asymmetric.

To enable user interaction with the computing device 1100, an input device 1145 can represent any number of input mechanisms, such as a microphone for speech, a touch-sensitive screen for gesture or graphical input, keyboard, mouse, motion input, speech and so forth. An output device 1135 can also be one or more of a number of output mechanisms known to those of skill in the art. In some instances, multimodal systems can enable a user to provide multiple types of input to communicate with the computing device 1100. The communications interface 1140 can generally govern and manage the user input and system output. There is no restriction on operating on any particular hardware arrangement and therefore the basic features here may easily be substituted for improved hardware or firmware arrangements as they are developed.

Storage device 1130 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1125, read only memory (ROM) 1120, and hybrids thereof.

The storage device 1130 can include software modules 1132, 1134, 1136 for controlling the processor 1110. Other hardware or software modules are contemplated. The storage device 1130 can be connected to the system bus 1105. In one aspect, a hardware module that performs a particular function can include the software component stored in a computer-readable medium in connection with the necessary hardware components, such as the processor 1110, bus 1105, display 1135, and so forth, to carry out the function.

FIG. 11B illustrates a computer system 1150 having a chipset architecture that can be used in executing the described method and generating and displaying a graphical user interface (GUI). Computer system 1150 is an example of computer hardware, software, and firmware that can be used to implement the disclosed technology. System 1150 can include a processor 1155, representative of any number of physically and/or logically distinct resources capable of executing software, firmware, and hardware configured to perform identified computations. Processor 1155 can communicate with a chipset 1160 that can control input to and output from processor 1155. In this example, chipset 1160 outputs information to output 1165, such as a display, and can read and write information to storage device 1170, which can include magnetic media, and solid state media, for example. Chipset 1160 can also read data from and write data to RAM 1175. A bridge 1180 for interfacing with a variety of user interface components 1185 can be provided for interfacing with chipset 1160. Such user interface components 1185 can include a keyboard, a microphone, touch detection and processing circuitry, a pointing device, such as a mouse, and so on. In general, inputs to system 1150 can come from any of a variety of sources, machine generated and/or human generated.

Chipset 1160 can also interface with one or more communication interfaces 1190 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 1155 analyzing data stored in storage 1170 or 1175. Further, the machine can receive inputs from a user via user interface components 1185 and execute appropriate functions, such as browsing functions by interpreting these inputs using processor 1155.

It can be appreciated that exemplary systems 1100 and 1150 can have more than one processor 1110 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A computer-implemented method comprising:
analyzing a manifest to determine a task, two or more users linked to the task, and a task preference criteria;
determining for the determined two or more users respective user attributes, wherein user attributes include each user's schedule; and
determining an optimum user from among the two or more users to perform the task based on the each user's schedule and at least one other factor; and
assigning the determined optimum user as owner of the task.

2. The method of claim 1, wherein the at least one other factor includes a user's past performance of a task.

3. The method of claim 1, wherein the at least one other factor includes a user's learned routine.

4. The method of claim 1, wherein the at least one other factor includes a user's other scheduled tasks.

5. The method of claim 1, wherein the determined optimum user is determined to be the optimum user even though the user that has a schedule conflict with a second scheduled task.

6. The method of claim 5, further comprising:
rescheduling the second scheduled task.

7. The method of claim 5, further comprising:
reassigning the second scheduled task to another user.

8. The method of claim 5, further comprising:
analyzing a task manifest associated to a third user, the third user being linked to the second scheduled task, to determine if the second scheduled task can be reassigned to the third user.

9. A system comprising:
a storage medium configured to store a task manifest database and a user database; and
a processor configured to access the task manifest database to identify a task, a first user and a second user linked to the task and a task preference criteria, the processor further configured to access the user database to identify users' attributes for the a first user and a second user linked to the task, wherein users' attributes include each users' schedule, and the processor further configured to determine an optimum user from among the a first user and a second user linked to the task, based on the a first user and a second user linked to the task schedule and at least one other factor, and to assign the determined optimum user as owner of the task.

10. The system of claim 9, wherein the at least one other factor includes a user's past performance of a task.

11. The system of claim 9, wherein the at least one other factor includes a user's learned routine.

12. The system of claim 9, wherein the at least one other factor includes a user's other scheduled tasks.

13. The system of claim 9, wherein the determined optimum user is determined to be the optimum user even though the user that has a schedule conflict with a second scheduled task.

14. The system of claim 13, further comprising:
rescheduling the second scheduled task.

15. The system of claim 13, further comprising:
reassigning the second scheduled task to another user.

16. A product comprising:
a computer readable medium; and
computer readable instructions, stored on the computer readable medium, that when executed are effective to cause a computer to:
analyze a manifest to determine a task, two or more users linked to the task, and a task preference criteria;
determine for the determined two or more users respective user attributes, wherein user attributes include each user's schedule; and
determine an optimum user from among the two or more users to perform the task based on the each user's schedule and at least one other factor; and
assign the determined optimum user as owner of the task.

17. The product of claim 16, wherein the at least one other factor includes a user's past performance of a task.

18. The product of claim 16, wherein the at least one other factor includes a user's learned routine.

19. The product of claim 16, wherein the at least one other factor includes a user's other scheduled tasks.

20. The product of claim 16, wherein the determined optimum user is determined to be the optimum user even though the user that has a schedule conflict with a second scheduled task.

21. The product of claim 20, further comprising:
rescheduling the second scheduled task.

22. The product of claim 20, further comprising:
reassigning the second scheduled task to another user.
